(19) United States
(12) Patent Application Publication
(10) Pub. No.: US 2010/0304634 A1
(43) Pub. Date: Dec. 2, 2010

(54) METHOD FOR PRODUCING PLASMA DISPLAY PANEL

(75) Inventors: Kenji HASEGAWA, Osaka (JP); Shougo NASU, Hyogo (JP); Kenji SATO, Osaka (JP); Syouzou NINOMIYA, Osaka (JP); Hisayo OOHATA, Osaka (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Osaka (JP)

(21) Appl. No.: 12/789,056

(22) Filed: May 27, 2010

(30) Foreign Application Priority Data
Jun. 2, 2009 (JP) 2009-132815

(51) Int. Cl. H01J 9/227

(52) U.S. Cl. 445/24

(57) ABSTRACT

The present invention provides a method for producing a plasma display panel, including a step of providing a back substrate with a barrier rib to form a plurality of recesses separated each other by the barrier rib, and a step of applying a phosphor ink to the recesses using an inkjet device, wherein the phosphor ink contains a phosphor having an average particle diameter of not less than 1.0 μm, a solvent and a dispersant, and the content of the phosphor in the phosphor ink is not less than 30 wt % and not more than 70 wt %.

### BACKGROUND OF THE INVENTION

1. Field of the Invention

The present invention relates to a method for producing a plasma display panel that is used for image display, particularly to a method for producing the plasma display panel using an inkjet device.

2. Description of Related Art

In recent years, a plasma display panel (hereinafter, abbreviated as PDP) has attracted attention as a color display device that can achieve a large but thin screen with a light weight.

In the PDP, image display is performed by making use of light emission from phosphor layers. For forming a phosphor layer in a production of a PDP, inkjet techniques have been proposed (e.g., see JP-A-2004-63246). Specifically, JP-A-2004-63246 discloses a method wherein an ink in which a phosphor having an average particle diameter of not less than 0.001 μm and less than 1.0 μm is dispersed in an organic solvent is prepared and then ejected from an end of an inkjet head.

However, in order to use the above phosphor having an average particle diameter of not less than 0.001 μm and less than 1.0 μm, it is required to crush a phosphor into a smaller size or classify a phosphor powder by sieving. When the phosphor is crushed, it is considered that the luminance may degrade and thus the emission properties of a PDP can be insufficient. On the other hand, when a phosphor having an average particle diameter of less than 1.0 μm is obtained by sieving, the yield is low. Furthermore, a phosphor having a small particle size agglomerates easily, and this causes a problem in that the dispersion of the phosphor into an ink is difficult.

In the meantime, when discharge cells are arranged more finely for higher definition along with higher pixel counts of a plasma display panel, it becomes difficult to apply a phosphor ink to each discharge cell. Employing a method for applying a phosphor ink using an inkjet device makes it easy to apply a phosphor ink to each discharge cell with high definition. However, in order to form a phosphor layer having a predetermined thickness in each discharge cell, it is required to increase the number of cycles of applying a phosphor ink by an inkjet device and drying it, resulting in low productivity.

### SUMMARY OF THE INVENTION

The present invention has been achieved to solve these problems, and it is an object of the present invention to provide a method for producing a PDP whereby luminance degradation of a phosphor can be prevented and a high definition PDP can be produced efficiently.

The above object can be attained by the following production method. It is a method for producing a PDP, including
a step of providing a back substrate with a barrier rib to form a plurality of recesses separated each other by the barrier rib, and
a step of applying a phosphor ink to the recesses using an inkjet device,

wherein the phosphor ink contains a phosphor having an average particle diameter of not less than 1.0 μm, a solvent and a dispersant, and the content of the phosphor in the phosphor ink is not less than 30 wt % and not more than 70 wt %.

According to the present invention, degradation of luminance of a phosphor is prevented by using a phosphor having an average particle diameter of not less than 1.0 μm, and a high definition PDP can be produced efficiently.

### BRIEF DESCRIPTION OF THE DRAWINGS

FIG. 1 is an exploded perspective view showing the structure of the PDP in the first embodiment of the present invention.

FIG. 2 is a sectional view of the discharge cell portion of the PDP in the first embodiment of the present invention.

FIG. 3 shows the electrode arrangement of the PDP in the first embodiment of the present invention.

FIG. 4 shows the cross-sectional shape of the discharge cell after applying the phosphor ink in the first embodiment of the present invention.

FIG. 5 is a schematic view of one example of the structure of the PDP device using the PDP produced by the present invention.

### DETAILED DESCRIPTION OF THE INVENTION

### First Embodiment

### (Structure of PDP)

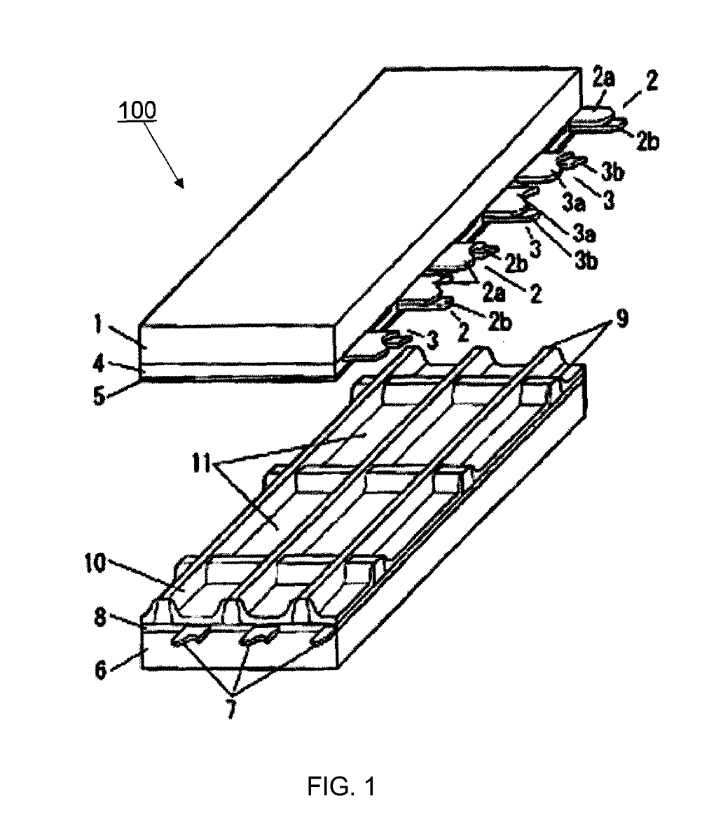

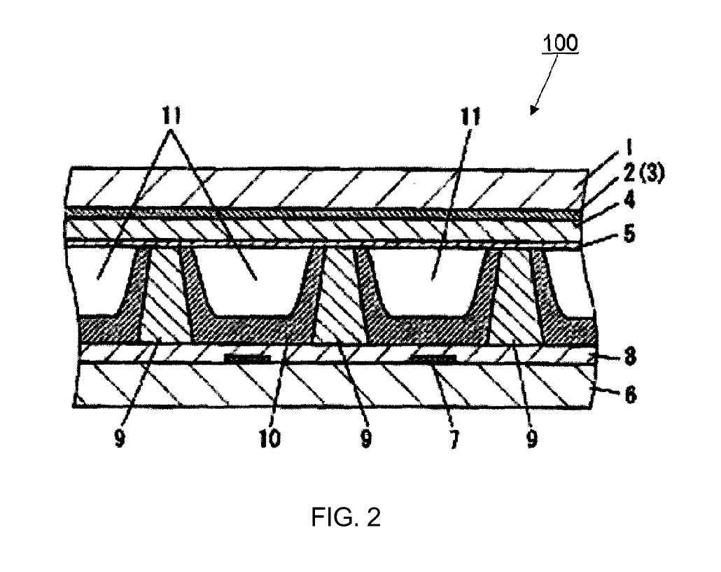

First, a general structure of a PDP to be produced is described. FIG. 1 is an exploded perspective view showing a structure of a PDP 100 in the first embodiment of the present invention, and FIG. 2 is a sectional view of a main portion of a discharge cell.

As shown in FIG. 1, the PDP 100 includes a front panel and a back panel with these panels being arranged facing each other. A lot of discharge cells 11 are formed between the front panel and the back panel.

The front panel includes a front substrate 1, scan electrodes 2, sustain electrodes 3, a dielectric layer 4, and a protective layer 5. The front substrate 1 is made of glass. A display electrode is composed of a pair of the scan electrode 2 and the sustain electrode 3, and a plurality of the display electrodes are formed parallel on the front substrate 1. The scan electrodes 2 and the sustain electrodes 3 are formed in the pattern in which an arrangement of a scan electrode 2—a sustain electrode 3—a sustain electrode 3—a scan electrode 2 is repeated. A dielectric layer 4 is formed so as to cover the display electrodes. Further, a protective layer 5 made of MgO is formed so as to cover the dielectric layer 4. Each of the scan electrodes 2 and the sustain electrodes 3 is made of conductive metal oxide such as ITO, SnO₂, or ZnO. Bus electrodes 2b, 3b that are made of metal such as Ag are formed on transparent electrodes 2a, 3a that have optical transparency.

The back panel includes a back substrate 6, data electrodes 7, a dielectric layer 8, and a barrier rib 9. The back substrate 6 is made of glass. A plurality of the data electrodes 7 made of a conductive material mainly containing Ag are formed parallel on the back substrate 6. The dielectric layer 8 is formed so as to cover the data electrodes 7. Further, the barrier rib 9 shaping a grid is formed on the dielectric layer 8. The barrier rib 9 separates adjacent discharge spaces. Phosphor layers 10 having any one color of red, green and blue are formed on the surface of the dielectric layer 8 and the side of the barrier rib 9.

The front panel and the back panel are arranged facing each other so that the data electrodes 7 intersects with the scan electrodes 2 and the sustain electrodes 3. A periphery of bonding surfaces of the front panel and the back panel is sealed. The discharge spaces are formed between the front panel and the back panel. In the discharge spaces, a discharge gas is enclosed.

Here, as shown in FIG. 2, in the discharge spaces between the front panel and the back panel, discharge cells 11 surrounded by the barrier rib 9 are formed. The discharge cell 11 is formed between the data electrode 7, and the scan electrode 2 and sustain electrode 3.

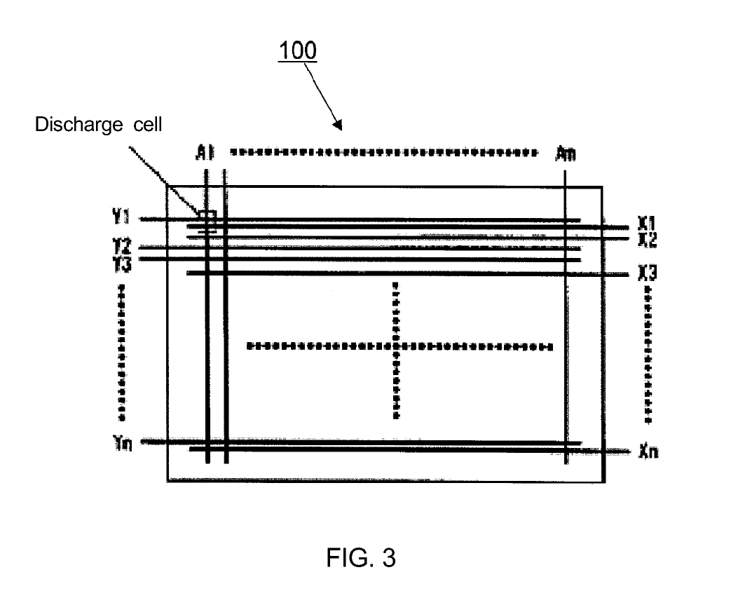

FIG. 3 shows an arrangement of the electrodes of the PDP 100 in the embodiment. N long scan electrodes Y1, Y2, Y3 . . . Yn (2 in FIG. 1) and n long sustain electrodes X1, X2, X3 . . . Xn (3 in FIG. 1) are arranged in a row direction, and m long data electrodes A1 . . . Am (7 in FIG. 1) are arranged in a column direction. A discharge cell is formed in the area where the data electrode A1 intersects with a pair of the scan electrode Y1 and the sustain electrode X1. M×n discharge cells are formed in the discharge spaces. Each of the electrodes is connected to connection terminals provided in a peripheral edge which is located outside of an image display area of a front panel and a back panel.

### (Production Method)

Hereinafter, a method for producing the PDP 100 according to the embodiment will be described.

The method for producing the PDP 100 typically includes a step of forming a front panel, a step of forming a back panel, a step of sealing the front panel and the back panel, and a sealing step. The step of forming a back panel includes a step of providing a back substrate with a barrier rib to form a plurality of recesses separated each other by the barrier rib, and a step of applying a phosphor ink to the recesses using an inkjet device. Since conventional steps of a method for producing a PDP can be applied to the steps other than the step of applying a phosphor ink, explanations of those steps are omitted.

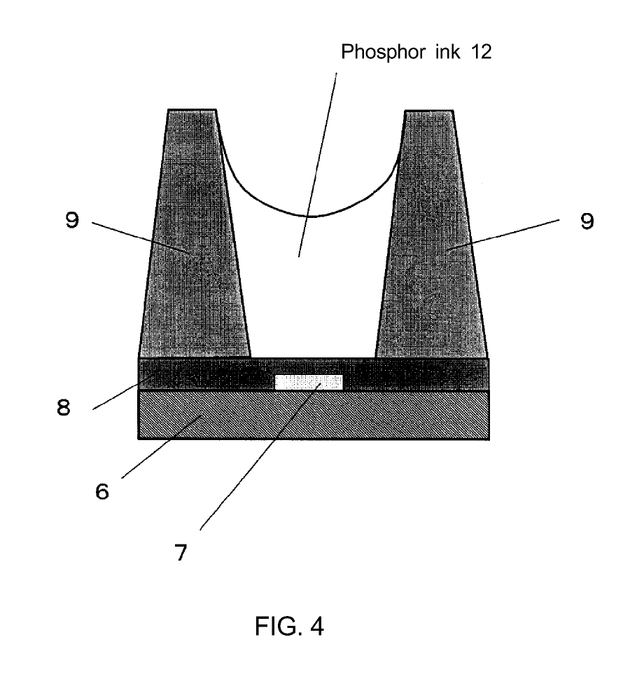

The step of applying a phosphor ink will be described in detail. For applying a phosphor ink, an inkjet device is used. Specifically, for example, a phosphor ink containing a phosphor is prepared. An inkjet head is allowed to move across the back panel to scan. The inkjet head ejects the phosphor ink containing a phosphor of a predetermined color to the discharge cell 11 surrounded by the barrier rib to a predetermined amount in one scan. The amount of the phosphor ink to be ejected into one discharge cell 11 is, for example, about ⅔ of the internal volume of the discharge cell 11. In this case, the amount of the ink to be dropped is adjusted considering wettability of the phosphor ink against the material of the back substrate 6 and the like. FIG. 4 shows the cross-sectional shape of the discharge cell 11 after applying the phosphor ink 12 to the barrier rib 9.

As a material of a blue phosphor, for example, BaMgAl₁₂O₁₇:Eu³⁺, BaMgAl₁₀O₁₇:Eu²⁺, BaMgAl₁₄O₂₃:Eu²⁺, Y₂SiO₅:Ce. (Ca, Sr, Ba)₁₉)PO₄)₆C₁₂:Eu²⁺, and (Zn, Cd)S:Ag may be used.

As a material of a green phosphor, for example, Zn₂SiO₄:Mn, and YBO₃:Tb may be used.

As a material of a red phosphor, for example, YBO₃:Eu³⁺, (YGd)BO₃:Eu³⁺, and Y(P, V)O₄:Eu³⁺ may be used. As a matter of course, materials of a blue phosphor, a green phosphor and a red phosphor are not limited thereto.

In the embodiment, the average particle diameter of the phosphor of each color is not less than 1.0 μm. The phosphor having an average particle diameter of not less than 1.0 μm has high luminance. The average particle diameter is preferably not less than 1.5 μm. In this regard, the maximum diameter of the phosphor has to be smaller than the diameter of the nozzle hole of the inkjet device, and is preferably 60% or less of the diameter of the nozzle hole. With consideration given to a diameter of a nozzle hole of an inkjet device commonly used, the average particle diameter of the phosphor is preferably not more than 10 μm, more preferably not more than 7 μm, and further preferably not more than 5 μm, from the viewpoint of preventing nozzle clogging. It should be noted that the average particle diameter here means a median diameter D50, and can be determined by a laser diffraction and scattering method.

A blue phosphor ink contains a blue phosphor. A green phosphor ink contains a green phosphor. A red phosphor ink contains red phosphor. In each phosphor ink, the phosphor particles are dispersed in a solvent such as butyl carbitol acetate and terpineol, in which a binder such as ethyl cellulose is dissolved. A dispersant is added to the each phosphor ink. The amount of the dispersant to be added is, for example, 0.5 to 2 wt % with respect to the weight of the phosphor. As the dispersant, for example, acrylic copolymers, alkyl ammonium salts, siloxanes, and the like may be used.

The viscosity of each phosphor ink at 25° C. is preferably not less than 10 mPa·s and not more than 50 mPa·s. Such a low viscosity can be achieved by using a phosphor having an average particle diameter of not less than 1.0 μm. The viscosity can be adjusted to not less than 10 mPa·s and not more than 50 mPa·s by adjusting the molecular weight and content of the binder such as ethyl cellulose. When the viscosity of the each phosphor ink is less than 10 mPa·s, the phosphor particles settle rapidly, and then precipitate and agglomerate in the inkjet device. Consequently, the concentration (content) of the phosphor particles in the ink droplet ejected from the nozzle hole of the inkjet head may vary and may not be kept constant. As a result, the phosphor layer 10 may not be formed on the side of the barrier rib so as to have a uniform thickness. On the other hand, when the viscosity is more than 50 mPa·s, ejection of the ink from the nozzle hole of the inkjet head may become difficult.

The amount of the phosphor ink to be applied to one discharge cell is determined in advance, and therefore, the maximum thickness of the phosphor layer to be formed in one cycle including application, drying, and firing of the phosphor ink is determined by the amount of the phosphor ink and the content of the phosphor in the phosphor ink. In order to form a phosphor layer having a predetermined thickness after drying and firing, the cycle including application and drying of the phosphor ink have to be preformed several times. However, the more times the cycle is repeated, the lower the productivity becomes. In light of this, the content of the each phosphor in the each phosphor ink is not less than 30 wt % and not more than 70 wt %. Such a high content of the phosphor can be achieved by using a phosphor having an average particle diameter of not less than 1.0 μm. When the content of the phosphor ink falls in the above range, a phosphor layer having a predetermined thickness can be formed in the smaller number of cycles including application and drying of the phosphor ink. For example, the phosphor layer having a predetermined thickness can be formed by performing one cycle. When the content of the phosphor in the phosphor ink is less than 30 wt %, the content of the phosphor in the phosphor ink to be applied in one cycle is too small. Therefore, in order to feed the phosphor ink at a sufficient amount for the internal volume of the barrier rib, larger number of the cycles of application and drying has to be performed, resulting in low productivity. On the other hand, when the content of the phosphor in the phosphor ink exceeds 70 wt %, the fluidity of the ink decreases since the content of the solvent is small. Hence, the ejection of the ink becomes difficult. It should be noted that the phosphor ink may be ejected from the inkjet head several times in one application of the phosphor ink.

As an example of the embodiment, an ink containing 50 wt % of a phosphor having an average particle diameter of 2 μm and a dispersant whose content was 0.5 wt % with respect to the weight of the phosphor was used for the each phosphor ink. As a solvent of the each phosphor ink, butyl carbitol acetate and terpineol were used. Further, a binder such as ethyl cellulose was added thereto. The viscosity of the each phosphor ink was measured at 25° C. and found to be 20 mPa·s.

After each of the blue phosphor ink, green phosphor ink and red phosphor ink was dropped to each discharge cell 11, drying step is performed in which the each phosphor ink is heated at the temperature of, for example, 80° C. or more to dry the each phosphor ink. In this case, the heating should be carried out at the temperature at which the ink component such as a dispersant does not decompose. Here, the heating temperature is determined depending heavily on the kind of the solvent used for the each phosphor ink, atmosphere, an exhaust speed, and the like.

Next, a firing step in which the each phosphor ink is heated at 100° C. or more is performed. After the firing step, the back panel of the PDP is completed. The dispersed dispersant component can be decomposed sufficiently by performing the firing step, and influence of the dispersant on the properties (e.g., emission luminance) of the PDP can be reduced. The heating temperature in the firing step is determined depending heavily on the kind of the solvent used for the each phosphor ink, atmosphere, an exhaust speed, decomposition temperatures of additives and a dispersant and the like. The firing step may be performed at the temperature at which residual components of the additives, the dispersant and the like can be decomposed to the extent where the residual components do not influence the properties of the PDP.

### Second Embodiment

Next, the second embodiment of the present invention will be described. The second embodiment differs from the first embodiment only in that each phosphor ink is different. Hence, only the phosphor inks will be described.

In the second embodiment, the phosphor ink is free from a binder made of a resin such as ethyl cellulose. In the second embodiment, the each phosphor ink has a good storage property. When a phosphor ink containing a binder made of a resin is stored sitting still, the phosphor particles settle with time, and precipitate on the bottom of a storage vessel of the phosphor ink. When the phosphor ink is left in this state, the phosphor particles may be bound by the resin component. However, the binder made of a resin is not added to the phosphor ink in this embodiment, and therefore, the phosphor particles is not bound even though the phosphor particles settle out during storage. The phosphor that has settled out in the each phosphor ink can be dispersed in the phosphor ink again by vibrating at an ultrasonic frequency and the like. On the other hand, when a phosphor ink contains a binder made of a resin such as ethyl cellulose, application of the phosphor ink to a side of a barrier rib becomes easy. However, when the phosphor ink is free from a binder made of a resin, the zeta potential of the phosphor is minus and the phosphor easily attaches to a barrier rib having a plus potential. Thus, application of the phosphor ink free from a binder made of a resin to a side of a barrier rib is also easy.

Hence, it is also preferable that in the second embodiment, the ink essentially consists of a phosphor, a solvent, and a dispersant.

As an example of the phosphor ink in the embodiment, a phosphor ink was prepared using butyl carbitol acetate and terpineol as a solvent. A phosphor was added at the content of 50 wt %, and a dispersant was added at the content of 0.5 wt % with respect to the weight of the phosphor. A binder made of a resin such as ethyl cellulose was not added. The viscosity of the phosphor ink was measured at 25° C. and found to be 15 mPa·s.

### Other Embodiment

The embodiments of the present invention are described as above. However, the present invention is not limited thereto. Other embodiments of the present invention are described collectively here.
(1) An average particle diameter of a phosphor, a particle size distribution of a phosphor, a kind of a solvent, a kind of additives, a weight ratio of components, and the like in a phosphor ink of the one color may be different from those in a phosphor ink of another color, respectively.
(2) One phosphor material may be used alone for each color, and a mixture of two or more kinds of phosphor materials may be used.

### [Application of PDP]

Next, a PDP device, which is an application of the PDP to be obtained by the production method of the present invention, will be described.

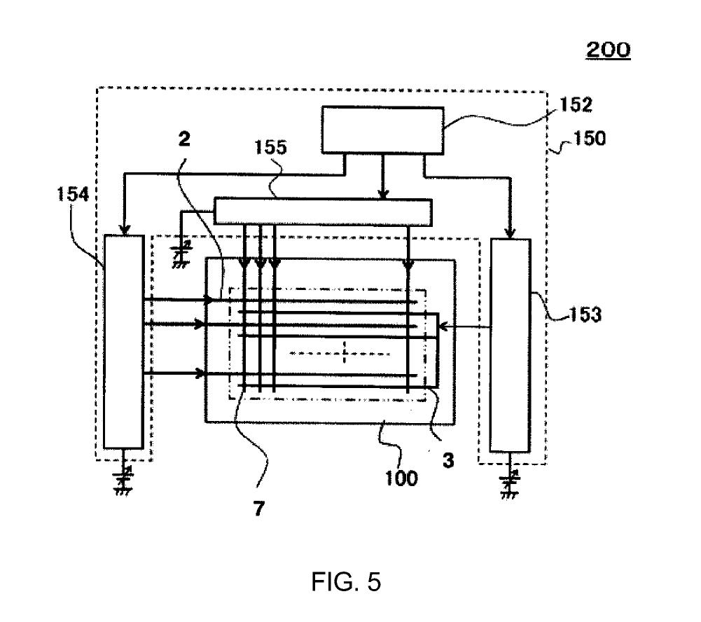

FIG. 5 is a schematic view of a structure of a PDP device 200 using the PDP 100. The PDP device is constructed by connecting the PDP 100 to a drive device 150. A display driver circuit 153, a display scan driver circuit 154, and an address driver circuit 155 are connected to the PDP 100. A controller 152 controls a voltage to be applied to these. An address discharge is generated by applying a predetermined voltage to a scan electrode 2 and a data electrode 7 in a discharge cell to be illuminated. The controller 152 controls this voltage to be applied. Thereafter, a pulse voltage is applied to between a sustain electrode 3 and the scan electrode 2 to generate a sustained discharge. Due to this sustained discharge, an ultraviolet ray is generated in the discharge cell in which the address discharge has been generated. A phosphor layer is excited by this ultraviolet ray and then emits light, so that the discharge cell is illuminated. A combination of lighting cells and non-lighting cells of respective colors displays an image.

### Feature of Embodiment

Features of the above embodiments will be listed below. It should be noted that the present invention is not limited to the below features.
[C1] A method for producing a plasma display panel includes
a step of providing a back substrate with a barrier rib (e.g., barrier rib 9) to form a plurality of recesses (e.g., discharge cells 11) separated each other by the barrier rib, and
a step of applying a phosphor ink to the recesses using an inkjet device,

wherein the phosphor ink contains a phosphor having an average particle diameter of not less than 1.0 μm, a solvent and a dispersant, and the content of the phosphor in the phosphor ink is not less than 30 wt % and not more than 70 wt %.

According to the method, a phosphor ink containing a phosphor having sufficient luminance can be applied efficiently using an inkjet device, and thus a high definition PDP can be produced efficiently.
[C2] In one preferred embodiment of the method for producing a plasma display panel according to C1, the phosphor ink is free from a binder made of a resin. According to this embodiment, even though the phosphor particles settle out during storage of the phosphor ink, the phosphor particles are not bound. Therefore, the storage of the phosphor ink is easy, and the phosphor ink can be used easily for the application after the storage.
[C3, 4] In the method for producing a plasma display panel according to C1 or C2, it is preferable that the viscosity of the phosphor ink at 25° C. be not less than 10 mPa·s and not more than 50 mPa·s. According to this, the phosphor particles are prevented from precipitating and agglomerating in the inkjet device, and ejection of the ink from a nozzle hole of an inkjet head is performed easily.

The invention may be embodied in other forms without departing from the spirit or essential characteristics thereof. The embodiments disclosed in this specification are to be considered in all respects as illustrative and not limiting. The scope of the invention is indicated by the appended claims rather than by the foregoing description, and all changes which come within the meaning and range of equivalency of the claims are intended to be embraced therein.

### INDUSTRIAL APPLICABILITY

As described above, the present invention is useful for achieving easily a high definition PDP.

What is claimed is:

1. A method for producing a plasma display panel, comprising
a step of providing a back substrate with a barrier rib to form a plurality of recesses separated each other by the barrier rib, and
a step of applying a phosphor ink to the recesses using an inkjet device,
wherein the phosphor ink contains a phosphor having an average particle diameter of not less than 1.0 μm, a solvent and a dispersant, and the content of the phosphor in the phosphor ink is not less than 30 wt % and not more than 70 wt %.

2. The method for producing a plasma display panel according to claim 1, wherein the phosphor ink is free from a binder made of a resin.

3. The method for producing a plasma display panel according to claim 1, wherein the viscosity of the phosphor ink at 25° C. is not less than 10 mPa·s and not more than 50 mPa·s.

4. The method for producing a plasma display panel according to claim 2, wherein the viscosity of the phosphor ink at 25° C. is not less than 10 mPa·s and not more than 50 mPa·s.
